(19) United States
(12) Patent Application Publication
(10) Pub. No.: US 2004/0228472 A1
(43) Pub. Date: Nov. 18, 2004

(54) Method and apparatus for controlling the transmit level of telephone terminal equipment

(76) Inventors: Mohamed El-Hennawey, Belleville (CA); John Lynch, Belleville (CA)

Correspondence Address: RIDOUT & MAYBEE LLP, Suite 2400, One Queen Street East, Toronto, M5C 3B1, CA

(21) Appl. No.: 10/437,047

(22) Filed: May 14, 2003

(51) Int. Cl. H04M 1/00; H04M 9/00

(52) U.S. Cl. 379/388.06; 379/387.01

(57) ABSTRACT

A method and apparatus for controlling the transmit level of transmitted signals from a telephone terminal device. A gain stage applies a gain or loss to the transmit signal to adjust its signal level. The gain or loss is determined by a transmit level control module. The transmit level control module measures the transmit signal during the course of a call to determine an average signal level during active speech and the average signal level during the call is used to build a historical estimate of average signal level for the device. Following each call, a gain factor is determined based upon the historical estimate and the gain factor is used by the gain stage in setting the gain or loss applied to the transmit signal of a subsequent call. The transmit signal control module provides for an adjustment to the signal level of the transmit signal that is customized to the historical speech characteristics of the user of the device.

### FIELD OF THE INVENTION

This invention relates to signal processing in telephony and, in particular, to a method and apparatus for controlling the transmit level of telephone terminal equipment.

### BACKGROUND OF THE INVENTION

An important aspect of high-quality telephony is ensuring that the telephone end-user receives a clear quality voice signal. In the course of signal transmission, if a signal becomes too large, there is a risk of saturation at various points in the telephone system. If saturation occurs, then the upper crests of the signal may become clipped. Clipping of the original signal results in a noticeably inferior voice signal for the receiving party. High signal levels can also negatively impact the echo canceller performance. Conversely, low signal levels result in listener dissatisfaction due to the inability to hear the other party clearly.

In order to ensure that transmitted signals remain within levels that will not overwhelm components of the telephone system and result in saturation or underwhelm the system and result in listener dissatisfaction, various international standards bodies have promulgated guidelines for “loudness ratings”. For example, in the context of digital wire-line telephones, the Telecommunications Industry Association has released Standard TIA/EIA-810-A. This Standard sets performance criteria for handset, headset, and hands-free telephone terminal equipment. In particular, the Standard specifies that a terminal should have a “Send Loudness Rating”of 8.0 dB, with a tolerance of ±4.0 dB. The Send Loudness Rating (SLR) is the conversion ratio of a defined acoustic signal at the mouth reference point to the transmit signal at the digital reference point. Further guidance regarding the measurement of SLR is given in the Standard and in the International Telecommunications Union publication ITU-T Recommendation P.79.

Telephone terminal devices typically permit a user to adjust the volume of the signal received by the device, but do not permit the user to adjust the level of the signal transmitted by the device.

Designing a terminal device to provide an SLR of 8 dB is very difficult given that the physical characteristics of two implementations of a device can vary widely, especially as regards the microphone transducer characteristics. Moreover, the volume of a user's speech varies widely from person to person. Some users have loud voices with high crests in volume, whereas other users are soft-spoken. Known terminal devices have difficulty accommodating all these circumstances and consistently achieving a nominal SLR of 8.0 dB.

Accordingly, there remains a need for a method and apparatus of controlling the level of the transmit signal in telephone terminal devices that addresses these shortcomings.

### SUMMARY OF THE INVENTION

The present invention provides a method and apparatus that measures the signal level of the transmit signal in a telephone terminal device and uses the measured signal level to build a historical signal level estimate. The historical signal level estimate is used to determine a gain or loss factor that is applied to the transmit signal. By determining the gain or loss based upon a history of measured signal levels, the present invention customizes the control of the transmit signal level to the characteristics of the device components and to the speech characteristics of the device user.

In one aspect, the present invention provides a method of controlling a transmit signal level of a telephone terminal device, the device including an input stage having a transducer, the input stage receiving an acoustic signal and outputting a transmit signal, the device including a signal processing module for receiving and processing the transmit signal, the signal processing module storing a historical transmission level. The method includes the steps of measuring an average signal level of the transmit signal, applying a gain or loss to the transmit signal based upon a gain factor, and thereby producing an adjusted transmit signal, updating the historical transmission level in response to the measured average signal level, and setting the gain factor based upon the updated historical transmission level.

In another aspect, the present invention provides a signal processing module for use in a telephone terminal device, the device including an input stage having a transducer, the input stage receiving an acoustic signal and outputting a transmit signal. The signal processing module includes a memory for storing a historical transmission level, a transmit level estimator for measuring the transmit signal and outputting an average signal level, a gain stage receiving the transmit signal and outputting an adjusted transmit signal, wherein the adjusted transmit signal is the transmit signal adjusted by a gain or loss as determined by the gain signal, a historical level update module receiving the average signal level and outputting the historical transmission level, and a mapping module receiving the historical transmission level and outputting the gain signal.

In yet a further aspect, the present invention provides a telephone terminal device, including an input stage having a transducer, the input stage receiving an acoustic signal and outputting a transmit signal, and a signal processing module. The signal processing module includes a memory for storing a historical transmission level, a transmit level estimator for measuring the transmit signal and outputting an average signal level, a gain stage receiving the transmit signal and outputting an adjusted transmit signal, wherein the adjusted transmit signal is the transmit signal adjusted by a gain or loss as determined by the gain signal, a historical level update module receiving the average signal level and outputting the historical transmission level, and a mapping module receiving the historical transmission level and outputting the gain signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show an embodiment of the present invention, and in which:

FIG. 1 shows a graph of transmit signal levels for a telephone terminal device under various circumstances;

FIG. 2 shows, in block diagram form, an embodiment of a telephone terminal device according to the present invention; and

FIG. 3 shows, in flowchart form, a method of controlling a transmit level for a telephone terminal device according to the present invention.

### DESCRIPTION OF SPECIFIC EMBODIMENTS

The following detailed description of specific embodiments of the present invention does not limit the implementation of the invention to any particular programming language or signal processing architecture. In one embodiment, the present invention is implemented, at least partly, using a digital signal processor. It will be understood that the present invention may be implemented using other architectures, including a microcontroller, a microprocessor, discrete components, or combinations thereof. Any limitations presented herein as a result of a particular type of architecture or programming language are not intended as limitations of the present invention.

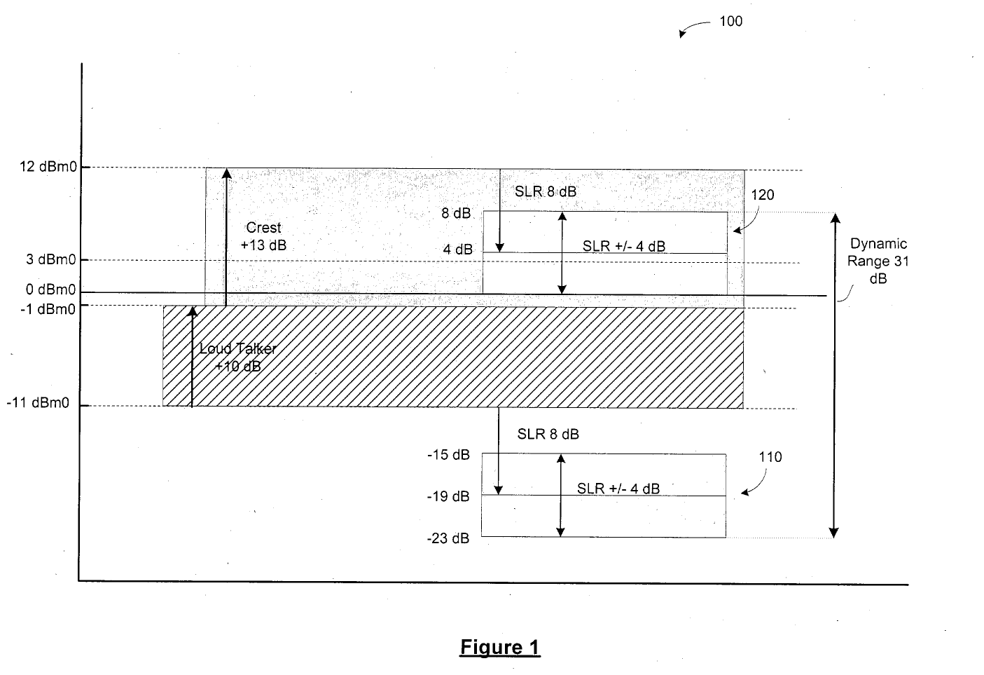

Reference is first made to FIG. 1, which shows a graph 100 of transmit levels for a telephone terminal device under various circumstances. The telephone terminal device may include a digital telephone, a voice-over-IP telephone, an analog telephone, a cellular telephone, computer microphone, or any other telephone terminal device.

As will be seen from the graph 100, a reference point of 0 dBm0 is first established. Saturation, and therefore clipping, is likely to occur at levels above +3 dBm0, which is indicated by a dashed line. The normal acoustic level of a relatively quiet speaker will be 11 dB below the reference point. This starting level is indicated with a dashed line at −11 dBm0.

A speaker that has a louder than normal voice may produce an acoustic level approximately 10 dB higher, meaning that the signal level will be at about −1 dBm0. Within the speech of such a speaker, there may be crests of volume. Crests are bursts of volume that may occur, for example, if the speaker laughs. Crests in volume contribute about 13 dB to the acoustic level. Accordingly, a “loud talker” may produce crests that reach an acoustic level of about +12 dBm0.

Therefore, it will be seen from the graph 100 that a telephone terminal device is required to accommodate a dynamic range of 31 dB in acoustic level.

The graph 100 shows the prescribed SLR under Standard TIA/EIA-810-A of 8 dB ±4 dB applied to the two cases of a quiet speaker and a loud speaker. The case of the quiet speaker with no crests of volume results in a terminal device transmit signal of −19 dBm0 ±4 dB, as indicated by reference numeral 110. The case of the loud speaker with a crest in volume results in a transmit signal of 4 dBm0 ±4 dB, as indicated by reference numeral 120. Accordingly, in the latter case, there is a significant likelihood of saturation and thus clipping of the transmitted signal.

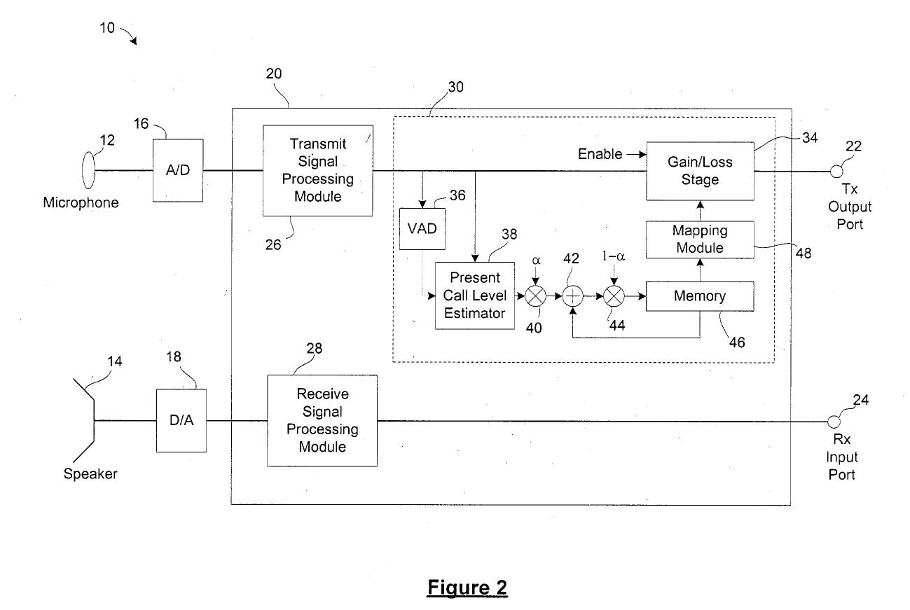

Reference is now made to FIG. 2, which shows an embodiment of a telephone terminal device 10 according to the present invention. The device 10 includes a microphone 12, a speaker 14, an analog-to-digital converter 16, and a digital-to-analog converter 18. The device 10 further includes a digital signal processor 20, a transmit output port 22 and a receive input port 24.

The microphone 12 receives acoustic voice waves from the user during a phone call. It includes a transducer for converting an acoustic signal to an analog electrical signal. The analog electrical signal is input into the analog-to-digital converter 16, which outputs a digital voice signal. The digital voice signal is input into the digital signal processor 20, which performs certain processing steps before providing an adjusted transmit signal at the transmit output port 22.

When a receive signal appears at the receive input port 24 it is input to the digital signal processor 20, which performs certain processing steps before providing a processed receive signal to the digital-to-analog converter 18. The digital-to-analog converter 18 converts the processed receive signal to an analog electrical signal, which it sends to the speaker 14.

The digital signal processor 20 includes a transmit signal processing module 26 and a receive signal processing module 28. The transmit signal processing module 26 performs signal processing upon the digital voice signal received from the analog-to-digital converter 16. The signal processing may include filtering, amplification, or other signal processing operations, as will be understood by those of ordinary skill in the art.

Similarly, the receive signal processing module 28 perform signal processing upon the receive signal arriving at the receive input port 24. The signal processing may include filtering, amplification, or other signal processing operations, as will be understood by those of ordinary skill in the art.

The digital signal processor 20 further includes a transmit level control module 30. The transmit level control module 30 receives a transmit signal from the transmit signal processing module 26 and it outputs the adjusted transmit signal to the transmit output port 22.

The transmit level control module 30 includes a gain/loss stage 34 that applies a gain or loss to the transmit signal from the transmit signal processing module 26. The gain/loss stage 34 outputs the adjusted transmit signal.

The transmit level control module 30 further includes a present call level estimator 38, a memory 46 for storing a historical level estimate, and a mapping module 48 for determining a gain factor based upon the historical level estimate. The gain factor is used by the gain/loss stage 34 to determine the magnitude of the gain or loss to apply to the transmit signal.

The present call level estimator 38 determines the average level of the transmit signal during the course of an active call. This measurement occurs earlier in the signal stream than application of the gain or loss, so the gain or loss is not factored into the average level. The measurement thus occurs in parallel with the application of the gain or loss to the transmit signal. The gain factor is not updated during the course of an active call, meaning that the gain or loss applied to the transmit signal remains the same throughout the duration of an active call, irrespective of the average level being measured by the present call level estimator 38.

Once the call is concluded, the average level is used to update the historical level estimate stored in the memory 46. Before the next call, the updated historical level estimate is used to determine, through the mapping module 48, a gain factor for use by the gain/loss stage 34 during the next call. In this manner, the transmit level control module 30 customizes the adjustment of the transmit signal level based upon the measured historical level of the transmit signal in the particular device. Accordingly, the device 10 compensates for tolerances in the device 10 components, and especially the microphone 12, and adapts to the speech characteristics of a particular user. If the user of the device 10 has a history of speaking loudly, then the device 10 may compensate by applying an appropriate loss to the transmit signal. Conversely, if the user of the device 10 typically speaks softly, then the device 10 may compensate by amplifying the transmit signal.

The present call level estimator 38 calculates an average level of the transmit signal. In one embodiment, the present call level estimator 38 bases the average level calculation only upon periods of active speech during the call. Accordingly, the transmit level control module 30 includes a voice activity detector (VAD) 36. The VAD 36 monitors the transmit signal and identifies periods of active speech. The VAD 36 provides a signal to the present call level estimator 38 during periods of active speech to trigger the present call level estimator 38 to perform the averaging calculation.

In some embodiments, the device 10 includes a VAD 36 external to the transmit level control module 30. For example, an IP-enabled device 10 typically includes a VAD as a part of the speech encoder. In such an embodiment, the existing VAD may be employed as the VAD 36 for triggering the present call level estimator 38. Alternatively, a separate VAD 36 may be implemented within the device 10. In most cases, a relatively simple design for the VAD 36 will suffice, since the VAD 36 is not being employed to determine the start and end of speech encoding and, thus, will not cause clipping or otherwise affect the quality of the speech encoding.

At the conclusion of a call, the present call level estimator 38 has calculated an average transmit signal level for the active speech period of the call. That average is then used to update the historical level estimate stored in the memory 46. In one embodiment, the updating of the historical level estimate is implemented using a weighting function, which determines the relative contribution of the present call average to the historical level.

As shown in FIG. 2, the updating of the historical level estimate may be implemented as a single-pole low-pass filter. The average call level determined by the present call level estimator 38 is multiplied by an averaging factor α in a first mixer 40. The product is then added to a feedback value from the historical level estimate stored in the memory 46. The sum is then multiplied by one minus the averaging factor α, to produce a new historical level estimate, which is then stored in the memory 46 in place of the previous historical level estimate.

The averaging factor a determines the extent to which the new average call level influences the historical level estimate. An averaging factor α of 1 would result in no filtering, meaning that the historical level estimate would be set to the new average call level. An averaging factor α of 0 results in total filtering, meaning that the historical level estimate would be unchanged by the new average call level.

In a further embodiment, the transmit level control module 30 may store a sequence of prior average call levels in the memory 46 and calculate a historical estimate using an averaging, weighting, or slope function and the set of stored averages. Other methods of building the historical level estimate based upon the average call levels determined by the present call level estimator 38 will be understood by those of ordinary skill in the art.

The historical level estimate produced as a result of the filtering process is stored in the memory 46 and is used by the mapping module 48 to determine the gain factor used by the gain/loss stage 34. The mapping module 48 may be implemented as a look up table, as an equation, or in some other manner by which the historical level estimate is translated into a gain/loss level for adjusting the transmit signal level in order to compensate for a higher or lower than expected transmit signal level.

In one embodiment, the gain/loss stage 34 receives an enable signal for enabling or disabling the operation of the gain/loss stage 34. Accordingly, the effect of the transmit level control module 30 upon the transmit signal be selectively enabled or disabled through the enable signal. While the gain/loss stage 34 is disabled, the transmit level control module 30 may continue to build up a historical level estimate for transmit signals.

The transmit level control module 30 may be implemented using a digital signal processor, a microcontroller, a microprocessor, discrete components, or any combination thereof. Such a processor or controller is suitably programmed to execute a program in firmware to perform the functions and calculations described herein. The programming will be within the understanding of those ordinarily skilled in the art of processor or controller programming.

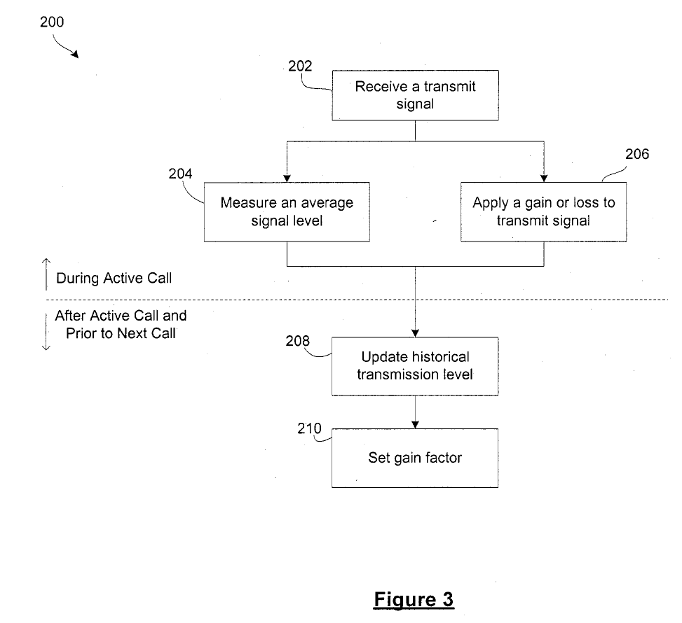

Reference is now made to FIG. 3, which shows, in flowchart form, a method 200 for controlling a transmit level of the telephone terminal device 10 (FIG. 2), according to the present invention.

The method 200 begins in step 202, when the transmit level control module 30 (FIG. 2) receives a transmit signal from the transmit signal processing module 26 (FIG. 2). This step occurs during a call made using the telephone terminal device 10. In step 204, the transmit level control module 30 measures the average signal level of the transmit signal over the duration of the call. As discussed above, this measurement may incorporate only the active voice periods of the transmit signal. In step 206, which also takes place while the call is occurring, a gain or loss is applied to the transmit signal by the gain/loss stage 34 (FIG. 2), as described above.

After the call is terminated and before the next call is initiated, in step 208 the transmit level control module 30 updates the historical transmission level stored in the memory 46 (FIG. 2). Based upon the updated historical transmission level, a gain factor is determined in step 210 for use by the gain/loss stage 34 in the course of the next call.

It will be understood by those of ordinary skill in the art that, while the above embodiment of the present invention has been described in the context of a digital telephone terminal, the present invention is not so limited. The present invention may be implemented in the context of digital telephones, VoIP telephones, analog telephones, or in other contexts, including wireless, wireline, narrowband or wideband telephony.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of controlling a transmit signal level of a telephone terminal device, said device including an input stage having a transducer, said input stage receiving an acoustic signal and outputting a transmit signal, said device including a signal processing module for receiving and processing said transmit signal, said signal processing module storing a historical transmission level, the method comprising the steps of:
(a) measuring an average signal level of said transmit signal;
(b) applying a gain or loss to said transmit signal based upon a gain factor, and thereby producing an adjusted transmit signal;
(c) updating said historical transmission level in response to said measured average signal level; and
(d) setting said gain factor based upon said updated historical transmission level.

2. The method claimed in claim 1, wherein said steps of measuring and applying occur during a first call, and said steps of updating and setting occur after said first call and prior to a second call.

3. The method claimed in claim 2, wherein said signal processing module includes a memory, and wherein said method further includes a step of storing said historical transmission level in said memory after said first call.

4. The method claimed in claim 1, wherein said transmit signal includes periods of active speech and wherein said step of measuring includes sensing said periods of active speech and measuring said average signal level during said periods of active speech.

5. The method claimed in claim 1, wherein said step of updating includes applying a filter to said measured average signal level with feedback from said historical transmission level.

6. The method claimed in claim 1, wherein said device is a digital telephone.

7. The method claimed in claim 1, wherein said device is a voice-over-IP telephone.

8. A signal processing module for use in a telephone terminal device, said device including an input stage having a transducer, said input stage receiving an acoustic signal and outputting a transmit signal, said signal processing module comprising:
(a) a memory for storing a historical transmission level;
(b) a transmit level estimator, said transmit level estimator measuring said transmit signal and outputting an average signal level based upon a measured average level of said transmit signal;
(c) a gain stage, said gain stage receiving said transmit signal and a gain signal and outputting an adjusted transmit signal, said adjusted transmit signal being said transmit signal adjusted by a gain or loss, wherein said gain or loss is determined by said gain signal;
(d) a historical level update module, said historical level update module receiving said average signal level from said transmit level estimator and outputting said historical transmission level to said memory; and
(e) a mapping module, said mapping module receiving said historical transmission level from said memory and outputting said gain signal.

9. The module claimed in claim 8, wherein said transmit level estimator and said gain stage operate during calls and said historical level update module operates between calls.

10. The module claimed in claim 8, wherein said transmit signal includes periods of active speech, and wherein said device further includes a voice activity detector for sensing said periods of active speech, and wherein said average signal level is measured using said periods of active speech.

11. The module claimed in claim 8, wherein said historical update module includes a filter receiving said average signal level as an input and said historical transmission level as a feedback.

12. The module claimed in claim 8, wherein said mapping module includes a look-up table for converting said historical level estimate to said gain signal.

13. The module claimed in claim 8, wherein said mapping module includes an equation for converting said historical level estimate to said gain signal.

14. The module claimed in claim 8, wherein said device is a digital telephone.

15. The module claimed in claim 8, wherein said device is a voice-over-IP telephone.

16. A telephone terminal device, comprising:
(a) an input stage having a transducer, said input stage receiving an acoustic signal and outputting a transmit signal; and
(b) a signal processing module, said signal processing module including,
(i) a memory for storing a historical transmission level;
(ii) a transmit level estimator, said transmit level estimator measuring said transmit signal and outputting an average signal level based upon a measured average level of said transmit signal;
(iii) a gain stage, said gain stage receiving said transmit signal and a gain signal and outputting an adjusted transmit signal, said adjusted transmit signal being said transmit signal adjusted by a gain or loss, wherein said gain or loss is determined by said gain signal;
(iv) a historical level update module, said historical level update module receiving said average signal level from said transmit level estimator and outputting said historical transmission level to said memory; and
(v) a mapping module, said mapping module receiving said historical transmission level from said memory and outputting said gain signal.

17. The device claimed in claim 16, wherein said transmit level estimator and said gain stage operate during calls and said historical level update module operates between calls.

18. The device claimed in claim 16, wherein said transmit signal includes periods of active speech, and wherein said device further includes a voice activity detector for sensing said periods of active speech, and wherein said average signal level is measured using said periods of active speech.

19. The device claimed in claim 16, wherein said signal processing module comprises a digital signal processor.
